(19) United States
(12) Patent Application Publication
(10) Pub. No.: US 2026/0342567 A1
(43) Pub. Date: Oct. 29, 2026

(54) PROTECTION OF ADDITIVE FAST FOURIER TRANSFORMS AGAINST SIDE-CHANNEL ATTACKS IN CRYPTOGRAPHIC OPERATIONS

(71) Applicant: Cryptography Research, Inc., San Jose, CA (US)

(72) Inventors: Mark Evan Marson, Carlsbad, CA (US); Helena Handschuh, Miami, FL (US); Michael Alexander Hamburg, Rosmalen (NL)

(21) Appl. No.: 19/110,808

(22) PCT Filed: Sep. 25, 2023
(86) PCT No.: PCT/US2023/033629

§ 371 Date: Mar. 11, 2025

Related U.S. Application Data
(60) Provisional application No. 63/410,895, filed on Sep. 28, 2022.

(51) Int. Cl. H04L 9/30; G06F 17/14; G06F 17/16

(52) U.S. Cl. CPC H04L 9/3093; G06F 17/142; G06F 17/16; H04L 2209/08

(57) ABSTRACT

Aspects and implementations disclosed are directed to systems and techniques protecting cryptographic operations that involve computing a discrete transform (DT) of a polynomial by randomizing basis vectors of a finite field, identifying a first auxiliary polynomial and a second auxiliary polynomial, computing the DT of the polynomial using the randomized basis vectors, the DT of the first auxiliary polynomial, and the DT of the second auxiliary polynomial, and computing a plaintext output corresponding to the ciphertext input using the DT of the polynomial. Further protection techniques include masking the polynomial and computing the DT of the polynomial using the DT of the masked polynomial.

### RELATED APPLICATIONS

This is a national stage application under 35 U.S.C. 371 of International Application PCT/US23/33629, filed Sep. 25, 2023, which claims benefit to U.S. Provisional Patent Application No. 63/410,895, filed Sep. 28, 2022, the contents of both are incorporated by reference in their entirety herein.

### TECHNICAL FIELD

Aspects of the present disclosure are directed to cryptographic computing applications, more specifically to protection of cryptographic operations, such as computations of transformations that involve secret information, from side-channel attacks.

### BRIEF DESCRIPTION OF THE DRAWINGS

The present disclosure will be understood more fully from the detailed description given below and from the accompanying drawings of various implementations of the disclosure.

FIG. 1 is a block diagram illustrating an example system architecture capable of protecting additive transformations performed as part of a cryptographic operation, in accordance with one or more aspects of the present disclosure.

FIG. 2 is an example illustration of a randomized additive Fast Fourier Transform performed in the course of a cryptographic operation, for improved protection against side-channel attacks.

FIG. 3 is an example illustration of a randomized additive Fast Fourier Transform, in which consecutive iterations are protected with basis vector randomization, in accordance with one or more aspects of the present disclosure.

FIG. 4 is an example illustration of a masked additive Fast Fourier Transform performed using polynomial masking, in accordance with one or more aspects of the present disclosure.

FIGS. 5A-B depict flow diagrams of an example method of protection, against side channel attacks, of cryptographic operations that use additive Fast Fourier Transforms by randomization of basis vectors, in accordance with one or more aspects of the present disclosure.

FIG. 6 depicts a flow diagram of an example method of protection, against side channel attacks, of cryptographic operations that use additive Fast Fourier Transforms by polynomial masking, in accordance with one or more aspects of the present disclosure

FIG. 7 depicts a block diagram of an example computer system operating in accordance with one or more aspects of the present disclosure.

### DETAILED DESCRIPTION

In public-key cryptography systems, a processing device may have various components/modules used for cryptographic operations on input messages. Input messages used in such operations are often large positive integers. Examples of cryptographic operations include, but are not limited to operations involving Rivest-Shamir-Adelman (RSA) and Elliptic Curve Diffie-Hellman (ECDH) keys, Digital Signature Algorithms (DSA), Elliptic Curve Digital Signature Algorithms (ECDSA), and the like. Cryptographic algorithms can involve modular arithmetic operations with a publicly-known modulus. Pre-quantum cryptographic applications often exploit the fact that factorizing the public modulus into privately-stored prime multipliers is a prohibitively difficult operation for a classical computer.

Progress in development of quantum computers, however, has placed some of the conventional algorithms (RSA, DSA, ECDH, EDCDSA) into jeopardy and has motivated development of a number of post-quantum cryptographic algorithms, such as hash-based algorithms, code-based algorithms, multivariate polynomial based algorithms, lattice-based algorithms, secret-key algorithms, symmetric key algorithms, and the like. Some of the post-quantum algorithms, e.g., the McEliece public key cryptosystem, use a representation of a ciphertext as a codeword with random errors. A private key allows one to identify and remove errors from the codeword and to recover the plaintext. Identifying errors may include finding roots of a large degree polynomial (error-locator polynomial), which is typically defined on a finite (Galois) field, GF(2^{m}) of 2^{m} polynomials representing the elements of the finite field. The technique of an additive Fast Fourier Transform (AFFT) allows an efficient evaluation of 2^{m} polynomial values for all 2^{m} elements of the field that, in turn, facilitates identification of roots of the error-locator polynomial. The AFFT techniques are based on a rescaling of m basis vectors of the field (with one of the basis vectors transformed to the unity) that allows one to group all 2^{m} polynomial elements into two sets of 2^{m-1} elements. Each of the two sets can then be evaluated as linear combinations of some auxiliary AFFTs of two suitably selected polynomials defined by an m−1 reduced set of basis vectors (after one of the basis vectors is turned to unity upon a rescaling). This process reduced computation of one 2^{m}-element AFFT via two 2^{m-1}-element AFFTs. Further iterations may be used to compute each of 2^{m-1}-element AFFTs via two 2^{m-2}-element AFFTs, and so on. The process may continue, with each iteration reducing the degree of the intermediate polynomials by one (at the cost of doubling the number of the intermediate polynomials) until the size of the polynomials is sufficiently small to allow direct efficient evaluation.

Conventional AFFT algorithms have been demonstrated to be vulnerable to template side-channel attacks. A side-channel attack may be performed by monitoring signals produced by electronic circuits of the targeted computer. Such signals may be acoustic, electric, magnetic, optical, thermal, and so on. By recording signals, a hardware trojan and/or a malicious software may correlate specific processor (and/or memory) activity with operations carried out by the processor. A simple power analysis (SPA) side-channel attack may involve examination of the electric power used by the device as a function of time. As the presence of noise dilutes the signal of the processor, a more sophisticated differential power analysis (DPA) attack may involve undertaking statistical analysis of power measurements performed over multiple cryptographic operations (or multiple iterations of a single cryptographic operation). An attacker employing DPA may filter out the noise component of the power signal (using the fact that the noise components may be uncorrelated between different operations or iterations) to extract the component of the signal that is representative of the actual processor operations, and to infer the value of the private key from this signal. During a template attack, an attacker accesses an attacker-controlled copy of the targeted computer and generates plaintext outputs for multiple ciphertext inputs in which known data (inputs) is combined with secret data (e.g., cryptographic keys, such as private keys).

Aspects and implementations of the present disclosure address these and other challenges of the existing technology by enabling systems and techniques of efficient protection of AFFTs for enhanced cryptographic protection of secret data. In some implementations, the basis vectors β₁ . . . βₘ of the finite field may be randomized every time a new polynomial is evaluated, to prevent an attacker from collecting sufficient statistics for determining the secret data. In some implementations, randomization of the basis vectors may be performed using multiplication by a random invertible matrix. In some implementations, randomization of the basis vectors may additionally be performed during each iteration of the AFFT that reduces the degree of the intermediate polynomials. Correspondingly, the inverse randomization transformation may be performed after completion of a given iteration. In some implementations, the inverse randomization transformation may be combined with randomization performed for the next iteration. In some implementations, polynomial masking may be performed in addition to (or instead of) the basis randomization. More specifically, a polynomial f(x) for which the AFFT is being computed may be masked by adding a random masking polynomial m(x) to f(x). This addition changes the computations throughout the whole set of AFFT iterations and efficiently masks secret information. In some implementations, the masking polynomial may be a low-degree polynomial (e.g., a first- or second-degree polynomial), since masking of even a few low coefficients of f(x) in the combination f(x)+m(x) may be sufficient to scramble all coefficients of various intermediate polynomials encountered in the course of AFFT computations. In some implementations, multiplicative masking may be performed, in which polynomial f(x) may be masked by multiplying it by a masking polynomial, f(x)·m(x). The masking polynomial is randomly generated subject to certain conditions discussed below. Numerous additional implementations are disclosed below. The advantages of the disclosed implementations include, but are not limited to, secure execution of cryptographic applications that deploy additive Fast Fourier Transforms, for increased protection of secret information against side-channel attacks and other unauthorized accesses.

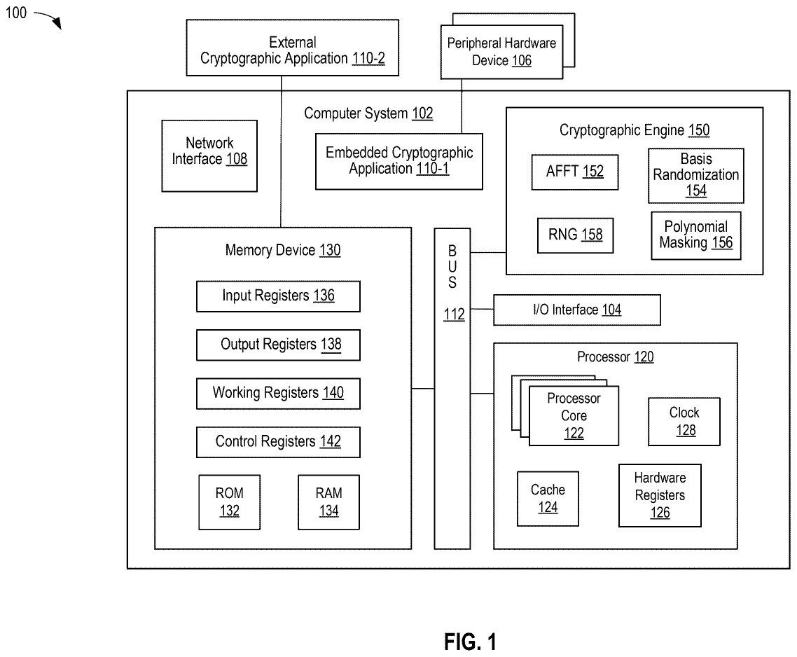

FIG. 1 is a block diagram illustrating an example system architecture 100 capable of protecting additive transformations performed as part of a cryptographic operation, in accordance with one or more aspects of the present disclosure. Example system architecture 100 may be a desktop computer, a tablet, a smartphone, a server (local or remote), a thin/lean client, and the like. Example system architecture 100 may be a smart card reader, a wireless sensor node, an embedded system dedicated to one or more specific applications (e.g., cryptographic applications 110-n), and so on. Example system architecture 100 may include (but need not be limited to) a computer system 102 having one or more processors 120 (e.g., central processing units (CPUs)) capable of executing binary instructions, and one or more memory devices 130. Herein “processor” or “processing device” refers to a device capable of executing instructions encoding arithmetic, logical, or I/O operations. In one illustrative example, a processing device may follow Von Neumann architectural model and may include an arithmetic logic unit (ALU), a control unit, and a plurality of registers. A processing device may be a single-core processor capable of executing one instruction at a time (or process a single pipeline of instructions), or a multi-core processor capable of simultaneous execution of multiple instructions. A processing device may be implemented as a single integrated circuit, two or more integrated circuits, or may be a component of a multi-chip module. A processing device may be or include a CPU, a graphics processing unit (GPU), a field-programmable gate array (FPGA), an application-specific integrated circuit (ASIC), or any combination thereof.

Example system architecture 100 may include an input/output (I/O) interface 104 to facilitate connection of computer system 102 to peripheral hardware devices 106 such as card readers, terminals, printers, scanners, internet-of-things devices, and the like. Example system architecture 100 may further include an internet interface 108 to facilitate connection to a variety of networks (Internet, wireless local area networks (WLAN), personal area networks (PAN), public networks, private networks, etc.), and may include a radio front end module and other devices (amplifiers, digital-to-analog and analog-to-digital converters, dedicated logic units, etc.) to implement data transfer to/from the computer system 102. Various hardware components of the computer system 102 may be connected via a bus 112, which may have its own logic circuits, e.g., a bus interface logic unit.

Example computer system 102 may support one or more cryptographic applications 110-n, such as an embedded cryptographic application 110-1 and/or external cryptographic application 110-2. Cryptographic applications 110-n may be secure authentication applications, public key signature applications, key encapsulation applications, key decapsulation applications, encrypting applications, decrypting applications, secure storage applications, and so on. External cryptographic application 110-2 may be instantiated on the same computer system 102, e.g., by an operating system executed by the processor 120 and residing in a memory device 130. Alternatively, external cryptographic application 110-2 may be instantiated by a guest operating system supported by a virtual machine monitor (hypervisor) executed by the processor 120. In some implementations, external cryptographic application 110-2 may reside on a remote access client device or a remote server (not shown), with the computer system 102 providing cryptographic support for the client device and/or the remote server.

Processor 120 may include one or more processor cores 122 having access to cache 124 (e.g., a single-level or multi-level cache) and one or more hardware registers 126. In some implementations, each processor core 122 may execute instructions to run a number of hardware threads, also known as logical processors. Various logical processors (or processor cores) may be assigned to one or more cryptographic applications 110-n, although more than one processor may be assigned to a single cryptographic application for parallel processing. Memory device 130 may refer to a volatile or non-volatile memory and may include a read-only memory (ROM) 132, a random-access memory (RAM) 134, as well as (not shown) electrically erasable programmable read-only memory (EEPROM), flash memory, flip-flop memory, or any other device capable of storing data. RAM 134 may be a dynamic random access memory (DRAM), synchronous DRAM (SDRAM), a static memory, such as static random access memory (SRAM), and the like.

Memory device 130 may include one or more registers, such as one or more input registers 136 to store cryptographic keys, input polynomials, basis vectors, and other input data for AFFT operations. Memory device 130 may further include one or more output registers 138 to store AFFT outputs, and one or more working registers 140 to store intermediate values generated during various AFFT iterations, including randomized basis vectors and masked polynomials. Memory device 130 may also include one or more control registers 142 for storing information about modes of operation, selecting a cryptographic algorithm, initializing operations of the AFFT processes, selecting a protection mode, e.g., basis randomization, iterative randomization, additive polynomial masking, multiplicative polynomial masking, or any combination thereof. Control registers 142 may communicate with one or more processor cores 122 and a clock 128, which may keep track of an iteration being performed. In some implementations, Registers 136-142 may be implemented as part of RAM 134. In some implementations, some or all of the registers 136-142 may be implemented separately from RAM 134. Some of or all registers 136-142 may be implemented as part of processor 120 (e.g., as part of the hardware registers 126). In some implementations, processor 120 and memory device 130 may be implemented as a single field-programmable gate array (FPGA).

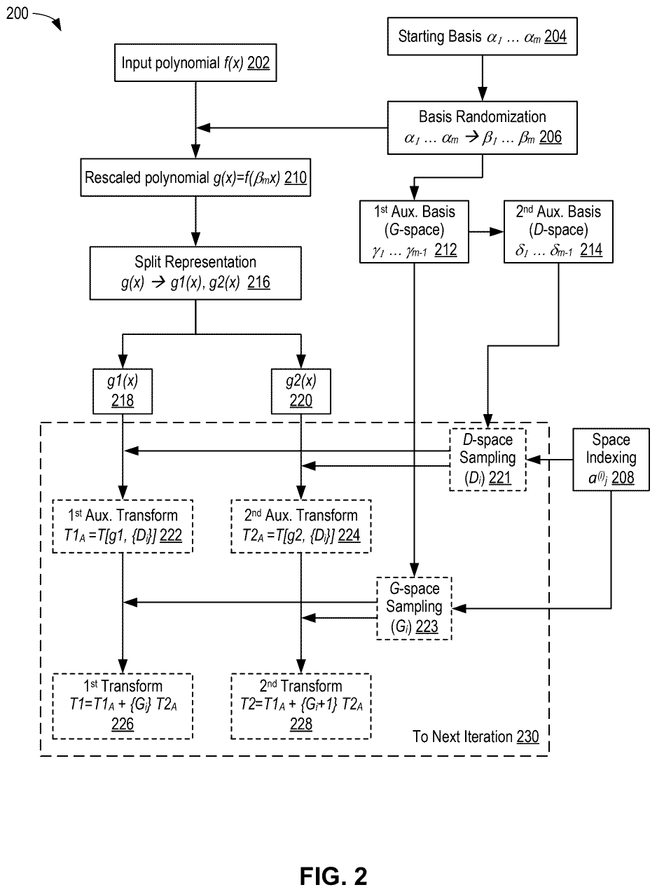

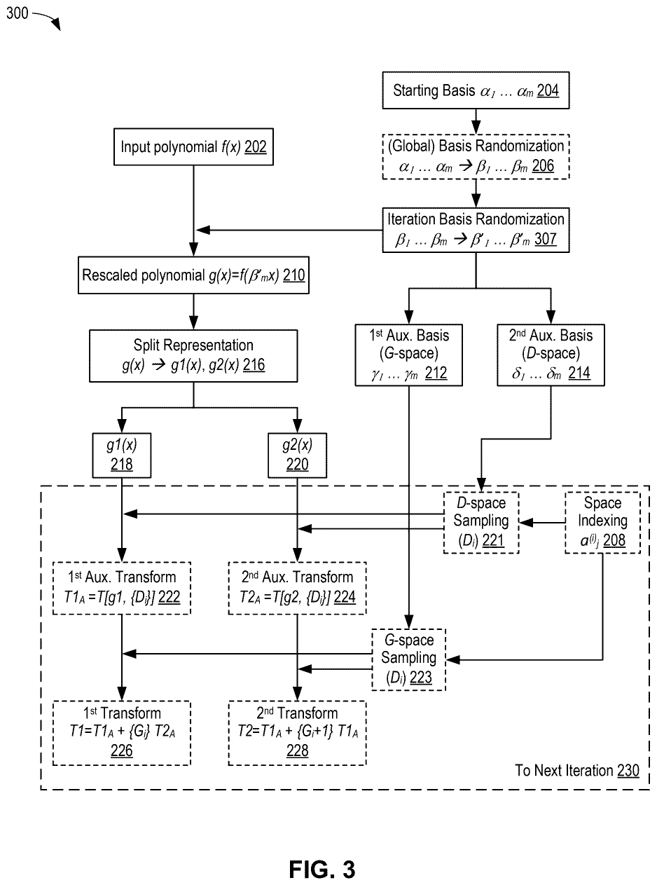

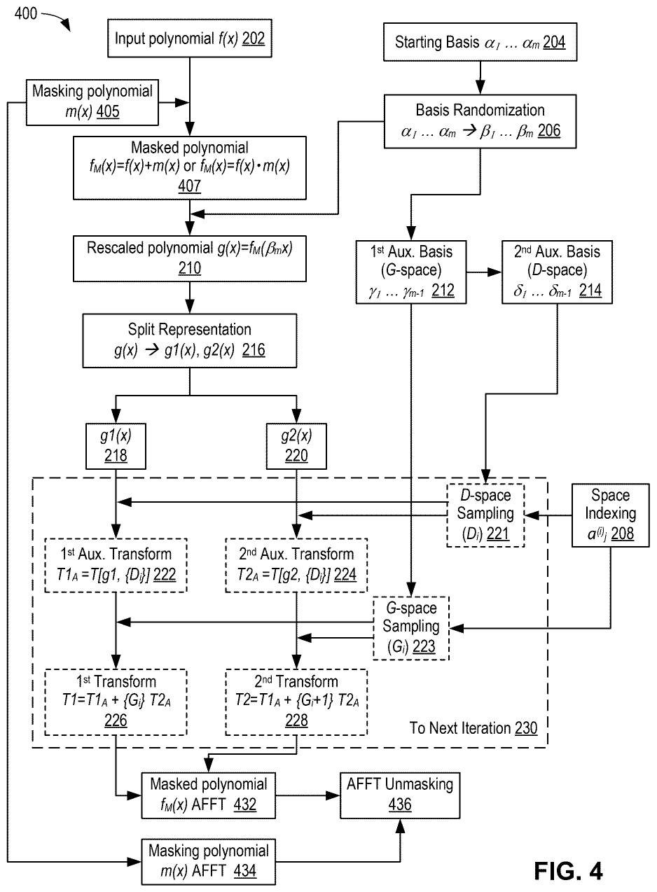

Computer system 102 may include a cryptographic engine 150 to support cryptographic operations of processor 120. Cryptographic engine 150 may be configured to perform side channel attack-resistant cryptographic operations, in accordance with implementations of the present disclosure. Cryptographic engine 150 may be a separate hardware component, e.g., as depicted in FIG. 1. In some implementations, cryptographic engine 150 may be implemented as a software (or firmware) module instantiated in memory device 130. In some implementations, cryptographic engine 150 may be partially implemented as a hardware component and partially as a software (or firmware) module. Cryptographic engine 150 may include an AFFT unit 152 that performs iterative AFFT computations on input data (polynomials). Cryptographic engine 150 may include basis randomization unit 154 that protects operations of AFFT unit 152 against side-channel attacks by randomizing basis vectors used during evaluation of polynomials in the course of AFFT computations, e.g., as described in more detail in conjunction with FIGS. 2-3. Similarly, a polynomial masking unit 156 protects AFFT computations by obfuscating input data using masking polynomials, e.g., as described in more detail in conjunction with FIG. 4. Cryptographic engine 150 may also include a random number generator (RNG) 158 to generate various masking values, randomization matrices, and masking polynomials, as may be used by basis randomization unit 154 and polynomial masking unit 156.

FIG. 2 is an example illustration of a randomized additive Fast Fourier Transform 200 performed in the course of a cryptographic operation, for improved protection against side-channel attacks. Conventional AFFT computations are described, e.g., in S. Gao and T. Mateer, “Additive Fast Fourier Transforms Over Finite Fields,” in IEEE Transactions on Information Theory, vol. 56, no. 12, pp. 6265-6272, December 2010, which is incorporated as a reference herein. In some implementations, randomized AFFT 200 may be performed by various components and/or modules of cryptographic engine 150 of FIG. 1. Randomization of the AFFT may be performed to protect an input polynomial f(x) 202, which may be a polynomial defined on a finite field GF(2^{m}), e.g.,

$$f ( x ) = {\sum }_{j = 1}^{m - 1} {f}_{j} {x}^{j}$$

with coefficients fⱼ in GF(2^{m}). A starting basis α₁ . . . αₘ 204 may be any set of m linearly independent (over GF(2)) elements of the field GF(2^{m}). The starting basis {αⱼ} 204 may be stored in the memory of a computing device (e.g., computing system 102 of FIG. 1) or cryptographic accelerator (e.g., cryptographic accelerator 150 of FIG. 1) performing the AFFT. In some implementations, the starting basis {αⱼ} 204 may be a basis permanently stored in the memory. In some implementations, the starting basis {αⱼ} 204 may be a basis that was used during a previous instance of the AFFT computation(s).

For protection against side-channel attacks, the starting basis {αⱼ} 204 may undergo a basis randomization 206: {αⱼ}→{βⱼ}. In some implementations, basis randomization may be performed using any invertible randomization matrix M, which may be an m×m matrix with elements Mⱼₖ in GF(2):

$$( \begin{matrix}{β}_{1} \\ … \\ {β}_{m}\end{matrix} ) = ( \begin{matrix}{M}_{11} & … & {M}_{1 m} \\ … & … & … \\ {M}_{m 1} & … & {M}_{mm}\end{matrix} ) \cdot ( \begin{matrix}{α}_{1} \\ … \\ {α}_{m}\end{matrix} )$$

The invertibility of the randomization matrix M ensures that the new basis {βⱼ} is also linearly independent. In some implementations, matrix M may have at least some elements that are randomly generated (e.g., by RNG 158 in FIG. 1). In some implementations, matrix M may have elements in GF(2). In some implementations, matrix M may be obtained by a random permutation of columns and/or rows of a unit matrix. In some implementations, after a random matrix M is generated, a check may be performed to determine a value of the determinant det M; the generated matrix may then be discarded or further modified if det M=0, and maintained and used for basis randomization 206 if det M≠0. In some implementations, the check is not performed. Instead, matrix M is generated in a way that ensures its invertibility. For example, a random matrix R is generated, in which all R_{j>k}=0 and all diagonal elements Rⱼ₌ₖ≠0, and multiplied by another (e.g., fixed) matrix S that has a non-zero determinant: M=S·R.

The implementation of FIG. 2 takes advantage of a possibility of computing the AFFT of the input polynomial f(x) 202 using any independent basis. In particular, basis {βⱼ} defines the corresponding space B with 2^{m} elements; the ith element of space B may be defined as

$${B}_{i} = {\sum }_{j = 1}^{m} {a}_{j}^{( i )} {β}_{j} , i = {\sum }_{j = 1}^{m} {a}_{j}^{( i )} {2}^{j - 1} .$$

$$The coefficients {a}_{j}^{( i )}$$

realize space indexing 208 and in one example non-limiting implementation represent bits of the binary representation of the index i (which may assume values in the interval 0≤i<2^{m}).

Obtaining the AFFT of input polynomial f(x) 202 may include rescaling the input polynomial f(x) using one of the basis vectors, e.g., βₘ, to obtained rescaled polynomial g(x)=f(βₘx) 210. A complementary rescaling may also be performed for the basis vectors, βⱼ→γⱼ=βⱼ/βₘ, generating a first auxiliary basis γ₁ . . . γₘ₋₁ 212. The first auxiliary basis {γⱼ} defines the reduced space G with 2^{m-1} elements. More specifically, the first auxiliary basis defines partitioning of the original space B into two (sub)spaces, space G and space G+1, with space G corresponding to the elements of the original space B for which

$${a}_{m}^{( i )} = 0$$

and space G+1 corresponding to the elements of space B for which

$${a}_{m}^{( i )} = 1.$$

The first auxiliary basis {γⱼ} 212 defines a reduced space G with 2^{m-1} elements. Additionally, a second auxiliary basis δ₁ . . . δₘ₋₁ 214 may be defined, such that

$${δ}_{j} = {γ}_{j}^{2} - {γ}_{j} .$$

The second auxiliary basis {δⱼ} defines space D with 2^{m-1} elements.

The rescaled polynomial g(x) 210 may then be expanded into the Taylor expansion in powers of x²−x:

$$g ( x ) = {\sum }_{i = 0}^{{2}^{m - 1} - 1} ( g {1}_{i} + g {2}_{i} \cdot x ) \cdot {( {x}^{2} - x )}^{i} ,$$

with coefficients g1ᵢ and g2ᵢ in the field GF(2). It now follows from

$${a}_{j}^{( i ) 2} mod 2 = {a}_{j}^{( i )} and 2 {a}_{j}^{( i )} mod 2 = 0$$

that for each ith element

$${G}_{i} = {\sum }_{j = 1}^{m - 1} {a}_{j}^{( i )} {γ}_{j}$$

of space G, the reduced polynomial is g(Gᵢ)=g1(Dᵢ)+Gᵢ·g2(Dᵢ), where the first auxiliary polynomial g1(x) 218 and the second auxiliary polynomial g2(x) 220 are

$$g 1 ( x ) = {\sum }_{i = 0}^{{2}^{m - 1} - 1} g {1}_{i} \cdot {x}^{i} , g 2 ( x ) = {\sum }_{i = 0}^{{2}^{m - 1} - 1} g {2}_{i} \cdot {x}^{i} ,$$

$$with {D}_{i} = {\sum }_{j = 1}^{m - 1} {a}_{j}^{( i )} {δ}_{j}$$

being the corresponding ith element of space D. Accordingly, evaluation of the reduced polynomial 210 amounts to finding an additive combination of the first auxiliary polynomial 218 and the second auxiliary polynomial 220, in which the latter is weighted by element Gᵢ. Similarly, for each ith element Gᵢ+1 of space G+1, the reduced polynomial is g(Gᵢ+1)=g1(Dᵢ)+(Gᵢ+1)·g2(Dᵢ). The sets of values {g1(Dᵢ)} and {g2(Dᵢ)} represent AFFTs of the respective auxiliary polynomials g1(x) and g2(x) over corresponding spaces G and G+1, each of the spaces having one half of the elements of the original space B.

Correspondingly, as depicted in FIG. 2, a first auxiliary transformation T1_{A} 222 may be applied to the first auxiliary polynomial g1(x) 218 and a second auxiliary transformation T2_{A} 224 may be applied to the second auxiliary polynomial g2(x) 220. Each transformation may be an AFFT, denoted via T[.,.] for brevity herein. For example, T[gj, {Dᵢ}] denotes the AFFT applied to polynomial gj(x) defined on space D with elements {Dᵢ}. The AFFT of the rescaled polynomial g(x) 210 is then determined as a combination (union) of the first auxiliary transformation T1_{A} 222 and a second auxiliary transformation T2_{A} 224, as described above. For example, the first transform T1 226 of the rescaled polynomial g(x) 210 may yield the values of g(x) for elements x∈G and the second transform T2 228 may yield the values of g(x) for elements x∈G+1, such that, symbolically, T1[g(x),{Gᵢ}]=T[g1, {Dᵢ}]+{Gᵢ}·T[g2, {Dᵢ}] and T2[g(x),{Dᵢ}]=T[g1, {Dᵢ}]+{Gᵢ+1}·T[g2, {Dᵢ}]. Sampling of values of Dᵢ for different index values i may be performed by D-space sampling 221 and sampling of values of Gᵢ may be performed by G-space sampling 223.

The operations of blocks 221-228 may be performed explicitly, e.g., when the current iteration is the final iteration of the AAFT. In those instances where the current iteration is not the final iteration, the operations of blocks 221-228 may be passed on to the next iteration 230 with each of the first auxiliary polynomial g1(x) 218 and the second auxiliary polynomial g2(x) serving as input polynomials for that next iteration. During the last iteration, the first auxiliary transformation T1_{A} 222 and the second auxiliary transformation T2_{A} 224 may be obtained in any suitable manner, e.g., by directly computing each of the auxiliary polynomials for all elements Dᵢ of space D. It should be understood that each iteration reduces the size of the space on which the corresponding polynomials are defined but increases the number of such polynomials. For example, if N iterations are being used, the last Nth iteration involves 2^{N} auxiliary polynomials defined on spaces of dimension 2^{m-N}. Correspondingly, each pair of the auxiliary polynomials may be processed in parallel to other pairs. The computations of the last iteration, therefore, may be parallelized using 2^{N-1} computational threads.

In some implementations, computation of randomized AFFT 200 of an input polynomial may include a forward path and a reverse path through a tree of iterations. The forward path may include, for each of N iterations, rescaling the polynomial received from the previous iteration (or rescaling the input polynomial 202, for the first iteration), representing the rescaled polynomial g(x) via two auxiliary polynomials g1(x) and g2(x), and passing these polynomials to the next iteration. Additionally, for each of N iterations, the forward path may include computing the first auxiliary basis 212 and the second auxiliary basis 214 and passing both bases to the next iteration. During the last Nth iteration, the auxiliary transforms 222 and 224 may be computed (using the respective first auxiliary basis 212 and second auxiliary basis 214 for the last Nth iteration), e.g., by direct evaluation, and then used to determine the first transform 226 and the second transform 228, which represent the lowest Nth iteration of the AFFT.

The reverse path through the tree of iterations may include passing the first transform 226 and the second transform 228 to the previous N−1th iteration and using the passed transforms as the first auxiliary transforms 222 and the second auxiliary transform 224 together with the first auxiliary basis 212 and second auxiliary basis 214 for the N−2th iteration) to determine the new first transform 226 and the second transform 228. The determined transforms 226-228 may then be passed to the N−2th iteration, and the process is repeated until the first transform 226 and the second transform 228 for the first iteration are obtained. The output AFFT is then read as the combination (union) of these transforms 226-228.

FIG. 3 is an example illustration of a randomized additive Fast Fourier Transform 300, in which consecutive iterations are protected with basis vector randomization, in accordance with one or more aspects of the present disclosure. Various operations of randomized AFFT 300 enumerated with the same numbers as the respective operations of randomized AFFT 200 (illustrated in FIG. 2) may be performed in substantially the same (or a similar) way as in FIG. 2. More specifically, a starting basis {αⱼ} 204 may undergo a suitable basis randomization 206: {αⱼ}→{βⱼ}. Starting basis {αⱼ} 204 may be a basis permanently stored in the memory. In some implementations, the starting basis {αⱼ} 204 may be a basis that was used during a previous instance of the AFFT computation(s). Basis randomization 206 may be performed globally, e.g., prior to the start of the first iteration of randomized AFFT 300. Additionally, at the start of each (or at least some of) iteration(s), an iteration basis randomization 307 may be performed, {βⱼ}→{β′ⱼ}. In some implementations, global basis randomization 206 is not performed and randomization starts with iteration basis randomization 307 for the first iteration. Global basis randomization 206 and/or iteration basis randomization 307 may be performed using any implementations described above in conjunction with FIG. 2.

Operations 210-230 of FIG. 3 may be performed in substantially the same (or similar) way as the corresponding operations of FIG. 2. During the forward path through the tree of iterations, sets of elements {Gᵢ} an {Dᵢ} may be stored at each node of the tree and, during the reverse path through the tree, to restore the polynomials g1(x), g2(x), g(x), at each iteration. In some implementations, only a portion of elements {Gᵢ} an {Dᵢ} may be stored while other elements may be computed using the stored portion.

FIG. 4 is an example illustration of a masked additive Fast Fourier Transform 400 performed using polynomial masking, in accordance with one or more aspects of the present disclosure. Various operations of masked AFFT 400 enumerated with the same numbers as the respective operations of masked AFFT 200 (illustrated in FIG. 2) and/or masked AFFT 300 (illustrated in FIG. 3) may be performed in substantially the same (or a similar) way. As shown in FIG. 4, polynomial masking may be combined with basis randomization 206. In some implementations, polynomial masking may be performed without basis randomization 206. In some implementations, polynomial masking may be combined together with basis randomization performed at each iteration of the AFFT (as described in conjunction with FIG. 3). Polynomial masking may use a masking polynomial m(x) 405 of any suitable degree, e.g., a degree that is smaller (or even significantly smaller) than the degree of input polynomial f(x) 202. In some implementations, masking polynomial m(x) 405 may have one, two, several, or all coefficients generated using a random number generator. In some implementations, the masking polynomial m(x) 405 may be selected as a low-degree polynomial, e.g., a polynomial of degree 1, 2, and the like, to reduce computational complexity of masking operations.

As illustrated in FIG. 4, input polynomial f(x) 202 may be masked by adding masking polynomial m(x) 405 to obtain a masked polynomial f_{M}(x) 407: f_{M}(x)=f(x)+m(x). In some implementations, the addition operation may be XOR (modulo 2) addition. Because AFFT is a linear transformation, the transform of the masked polynomial 407 is equal to the sum of the transforms of the input polynomial 202 and the masking polynomial 405: T[f_{M}(x)]T[f(x)]+T[m(x)]. (The sum here should be understood as the sum of ith element of each of the input polynomial f(x) 202 and masking polynomial m(x) 405.) Correspondingly, the transform of the input polynomial 202 may be determined by computing the transform of the masked polynomial 210 and subtracting the transform of the masking polynomial 404, T[f(x)]=T[f_{M}(x)]−T[m(x)] (which, for XOR operations, is the same as addition T[f(x)]=T[f_{M}(x)]+T[m(x)]). As illustrated in FIG. 4, the transform of the masked polynomial 432 may be computed substantially as described above in conjunction with FIG. 2 and FIG. 3, e.g., with T[f_{M}(x)] obtained as a combination (union) of the first transform 226 and the second transform 228 of the first iteration of the reverse path through the tree of iterations of the AFFT algorithm. The transform of the masking polynomial 434 may be computed using any suitable way. For example, the transform of the masking polynomial 434 may be obtained by a second application (e.g., in parallel) of operations 210-230 to the masking polynomial m(x) 405. In some implementations, the transform of the masking polynomial 434 may be obtained by a direct evaluation of the masking polynomial m(x) 405 at various x∈B. AFFT unmasking 436 may then use the transform of the masked polynomial 432 and the transform of the masking polynomial 434 to compute the transform on the input polynomial f(x), as described above.

In some implementations, input polynomial f(x) 202 may be masked by multiplying it by a masking polynomial m(x) 405 to obtain a masked polynomial f_{M}(x) 407: f_{M}(x)=f(x)·m(x). For example, in some cryptographic systems (e.g., McEliece systems), the decryption protocol may aim to determine roots of input polynomial f(x) 202. Correspondingly, roots of f(x) may be identified among roots of f_{M}(x) after eliminating spurious roots of m(x). This may be accomplished using a number of techniques. In one example, roots of input polynomial f(x) (for properly generated ciphertexts) may be known to be in a certain subset (code support) of the finite field over which the polynomial operations are defined while masking polynomials m(x) may be generated with roots aⱼ being selected outside the code support, e.g., m(x)=Πⱼ(x+aⱼ). Correspondingly, AFFT unmasking 436 may select, as roots of input polynomial f(x) 202, those roots of masked polynomial f_{M}(x) 407 that are within the code support. In another example, masking polynomial m(x) 405 may be chosen to have no roots in GF(2^{m}). For example, the polynomial m(x)=x²+ax+a²b does not have roots in GF(2^{m}) if Tr(b)=1, where Tr(b) denotes a trace from GF(2^{m})→GF(2). Since the trace is a linear function over GF(2^{m}), it is possible to choose a random element b with Tr(b)=1, e.g., by selecting all bits of b except one bit randomly and then choose that last bit according to an affine function that guarantees that Tr(b)=1. This ensures that f_{M}(x)=f(x)·m(x) has the same roots as f(x) while efficiently masking the computations. Different techniques of multiplicative masking may be combined. For example, the masking polynomial m(x) 405 may be obtained as a product, m(x)=m₁(x)·m₂(x), where polynomial m₁(x) has no roots in GF(2^{m}) while polynomial m₂(x) has roots in GF(2^{m}) but outside the code support portion. The degrees of the polynomials m₁(x) and m₂(x) need not be fixed and may be varied to further obfuscate the number of roots of f_{M}(x).

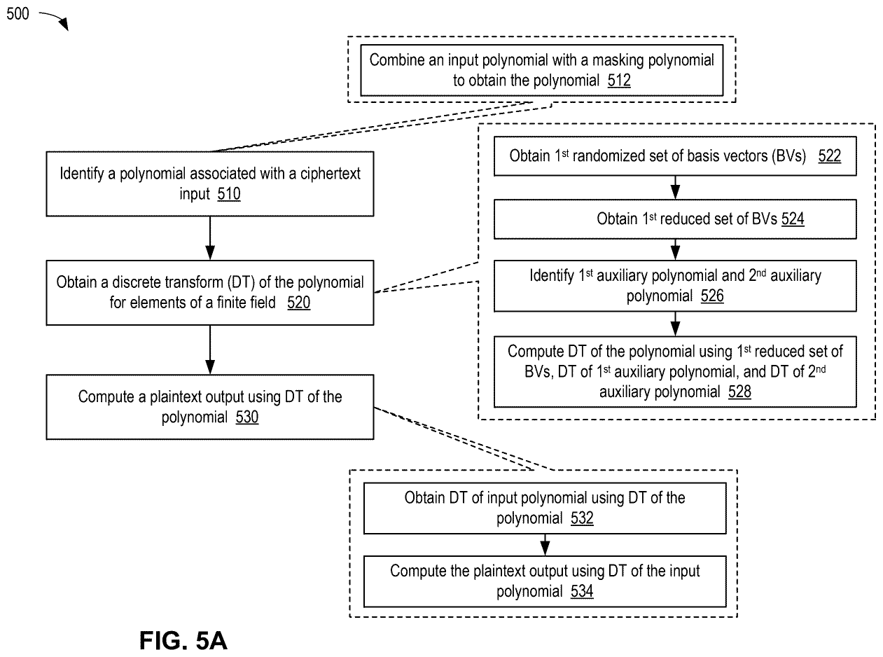

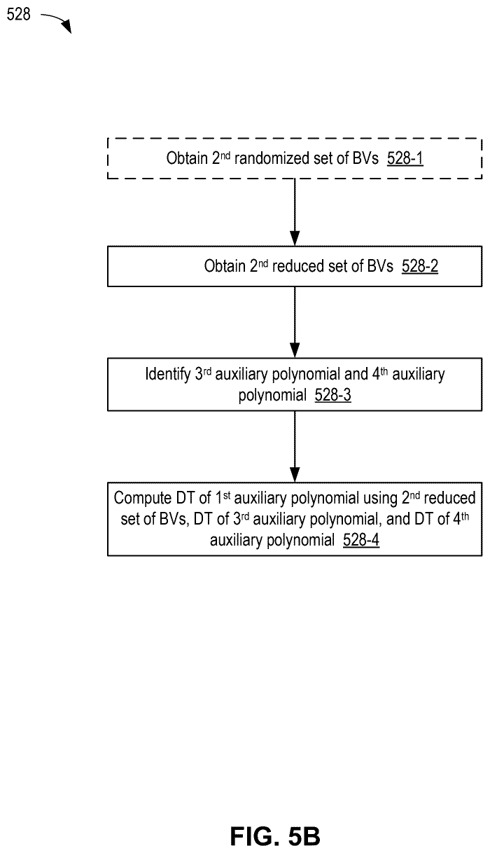

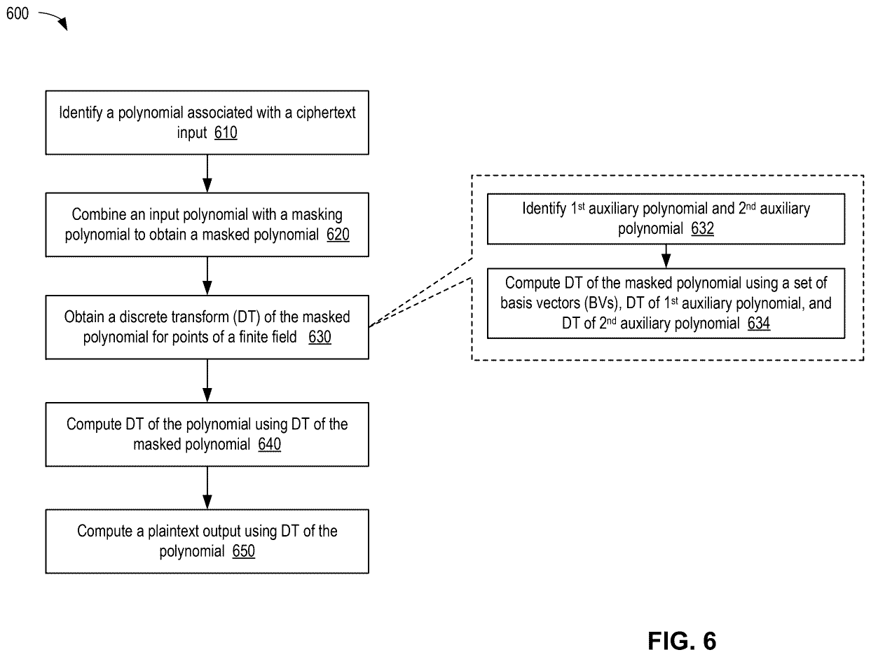

FIGS. 5-6 depict flow diagrams of example methods 500 and 600 of protection against side channel attacks of additive Fast Fourier Transforms performed in the course of a cryptographic operation, in accordance with one or more aspects of the present disclosure. Method 500 and/or method 600 disclosed below, and/or each of their individual functions, routines, subroutines, or operations may be performed by one or more processing units of the computing system implementing the respective methods, e.g., processor 120 of computer system 102. In some implementations, method 500 and/or method 600 may be performed by an arithmetic logic unit, an FPGA, an ASIC, a cryptographic accelerator, a dedicated hardware circuit, and the like, or any suitable processing logic, hardware or software or a combination thereof. In certain implementations, any of methods 500 and/or 600 may be performed by a single processing thread. Alternatively, any of methods 500 and/or 600 may be performed by two or more processing threads, each thread executing one or more individual functions, routines, subroutines, or operations of the method. In an illustrative example, the processing threads implementing any of methods 500 and/or 600 may be synchronized (e.g., using semaphores, critical sections, and/or other thread synchronization mechanisms). Alternatively, the processing threads implementing any of methods 500 and/or 600 may be executed asynchronously with respect to each other. Various operations of any of methods 500 and/or 600 may be performed in a different order compared with the order shown in FIGS. 5-6. Some blocks may be performed concurrently with other blocks. Some blocks of any of methods 500 and/or 600 may be optional.

FIGS. 5A-B depict flow diagrams of an example method 500 of protection, against side channel attacks, of cryptographic operations that use additive Fast Fourier Transforms by randomization of basis vectors, in accordance with one or more aspects of the present disclosure. Method 500 may be performed by one or more processing units of computer system 102, e.g., processor 120. In some implementations, a cryptographic operation protected by method 500 may involve decrypting a ciphertext input and recovering a plaintext output encrypted in the ciphertext input. In some implementations, the cryptographic operation may be performed as part of McEliece public key encryption/decryption cryptography. At illustrated in FIG. 5A, at block 510, method 500 may include identifying, by a processing device, a polynomial (e.g., input polynomial f(x) 202 in FIG. 2) associated with a ciphertext input into the cryptographic operation. For example, the polynomial may be a locator polynomial of an error correction code or a polynomial representative of such a locator polynomial (e.g., a polynomial related to the locator polynomial by one or more transformations). In some implementations, computing the plaintext output may include identifying one or more roots of the locator polynomial. In some implementations, identifying roots of the locator polynomial may include computing and using a discrete transform (DT) of the polynomial. For example, DT may be (or include) an Additive Fast Fourier Transform.

At block 520, the processing device performing method 500 may obtain the DT of the polynomial for a plurality of elements of a finite field. In some implementations, the finite field may be a GF(2^{m}) field, where m is an integer number. In some implementations, obtaining the DT of the polynomial may include performing a plurality of iterations, each iteration representing the DT of the polynomial via DTs of reduced size. For example, the first iteration may represent the DT of 2^{m} elements via two DTs of 2^{m-1} elements each, the second iteration may represent two DTs of 2^{m-1} elements via four DTs of 2^{m-2} elements each, and so on. In some implementations, the first iteration may include operations illustrated with the middle callout portion of FIG. 5A. More specifically, at block 522, the processing device performing method 500 may randomize a set of basis vectors for the finite field (e.g., starting basis α₁ . . . αₘ 204 in FIG. 2) to obtain a first randomized set of basis vectors (e.g., masked basis β₁ . . . βₘ in FIG. 2). In some implementations, randomizing the set of basis vectors may include multiplying the set of basis vectors (e.g., basis vectors α₁ . . . αₘ) by a randomization matrix that includes one or more random elements. In some implementations, randomizing the set of basis vectors may include permuting two or more vectors of the set of basis vectors. In some implementations, permuting vectors of the set of basis vectors may include rescaling one or more of the basis vectors.

At block 524, method 500 may continue with the processing device obtaining, using the first randomized set of basis vectors, a first reduced set of basis vectors (e.g., the first auxiliary basis 212 in FIG. 2). For example, obtaining the first reduced set of basis vectors may include rescaling various basis vectors by one of the basis vectors, γⱼ=βⱼ/βₘ, such that the reduced set of basis vectors γ₁ . . . γₘ₋₁ has fewer (e.g., m−1) vectors than the set of basis vectors α₁ . . . αₘ (with the remaining basis vector γₘ assuming fixed value 1).

At block 526, method 500 may continue with the processing device identifying, based on the polynomial, a first auxiliary polynomial (e.g., g1(x) 218 in FIG. 2) and a second auxiliary polynomial (e.g., g2(x) 220 in FIG. 2). Identifying the first auxiliary polynomial and the second auxiliary polynomial may include rescaling the polynomial (e.g., f(x) in FIG. 2), obtaining the Taylor expansion of the polynomial, and/or performing other operations.

At block 528, method 500 may continue with the processing device computing the DT of the polynomial using the first reduced set of basis vectors (e.g., γ₁ . . . γₘ₋₁), the DT of the first auxiliary polynomial (e.g., the first auxiliary transform T1_{A} 222 in FIG. 2), and the DT of the second auxiliary polynomial (e.g., the second auxiliary transform T2_{A} 224 in FIG. 2). For example, computing the DT of the polynomial may include computing linear combinations of the first auxiliary transform T1_{A} 222 and the second auxiliary transform T2_{A} 224 in FIG. 2. As illustrated in FIG. 5B, operations of block 528 may include additional iterations to segment the first auxiliary transform T1_{A} 222 (and, similarly, the second auxiliary transform T2_{A} 224) into even smaller transforms.

More specifically, at block 528-1, the processing device may perform randomization of the first reduced set of basis vectors to obtain a second randomized set of basis vectors. At block 528-2, the processing device may obtain, using the second randomized set of basis vectors, a second reduced set of basis vectors. At block 528-3, the processing device may identify, based on the first auxiliary polynomial, a third auxiliary polynomial and a fourth auxiliary polynomial, and at block 528-4 may compute the DT of the first auxiliary polynomial using the second reduced set of basis vectors, the DT of the third auxiliary polynomial, and the DT of the fourth auxiliary polynomial. In some implementations, operations of block 528-1 are not performed and the second reduced set of basis vector may be obtained directly by further reducing the first reduced set of basis vectors (e.g., from m−1 basis vectors to m−2 basis vectors, with m−1th basis vector taking fixed value 1). The process illustrated in FIG. 5B may further continue for one or more additional iterations.

With a continuing reference to FIG. 5A, at block 530, method 500 may include computing, by the processing device, a plaintext output corresponding to the ciphertext input using the DT of the polynomial. For example, the DT of the polynomial may be used to identify locations of roots of the polynomial, and the plaintext output may be computed using the identified root locations.

In some implementations, as illustrated with the top callout portion and the bottom callout portion of FIG. 5A, method 500 may provide additional protections of the cryptographic operation using polynomial masking. More specifically, the polynomial (e.g., polynomial f_{M}(x) 407 of FIG. 4) may be masked by combining (e.g., adding or multiplying) an input polynomial f(x) 202 with a masking polynomial m(x) 405. In implementations that deploy polynomial masking, the processing device may obtain, at block 532, the DT of the input polynomial f(x) using the DT of the polynomial f_{M}(x). In some implementations, the DT of the input polynomial f(x) may be obtained by computing and using the DT of the masking polynomial m(x) In other implementations, the masking polynomial m(x) may be evaluated directly (e.g., in the instances of low-degree masking polynomials) and the DT of the masking polynomial need not be computed. At block 534, the processing device may compute the plaintext output using the DT of the input polynomial. In some implementations, the masking polynomial may be a low-degree polynomial, e.g., a first-degree polynomial or a second-degree polynomial. In some implementations, polynomial masking may be additive masking, f_{M}(x)=f(x)+m(x). In some implementations, polynomial masking may be multiplicative masking, f_{M}(x)=f(x)·m(x). In the instances of multiplicative masking, method 500 may include identifying roots of the masked polynomial f_{M}(x) that are not roots of the masking polynomial m(x), e.g., by constructing m(x) that does not have roots in the field over which polynomial f(x) is defined (e.g., GF(2^{m})) or by selecting m(x) that does not have roots in a portion (e.g., code support) of that field.

FIG. 6 depicts a flow diagram of an example method 600 of protection, against side channel attacks, of cryptographic operations that use additive Fast Fourier Transforms by polynomial masking, in accordance with one or more aspects of the present disclosure. Method 600 may be performed by one or more processing units of computer system 102, e.g., processor 120. In some implementations, a cryptographic operation protected by method 600 may involve decrypting a ciphertext input and recovering a plaintext output encrypted in the ciphertext input. In some implementations, the cryptographic operation may be performed as part of the McEliece public key encryption/decryption cryptography. At block 610, the processing device implementing method 600 may identify a polynomial (e.g., input polynomial f(x) 202 in FIG. 4) associated with a ciphertext input into the cryptographic operation. In some implementations, the polynomial may be a locator polynomial (or a polynomial representative of a locator polynomial) of an error correction code. At block 620, method 600 may continue with the processing device combining the polynomial with a masking polynomial (e.g., masking polynomial m(x) 405 in FIG. 4) to obtain a masked polynomial (e.g., masked polynomial f_{M}(x) 407 in FIG. 4).

At block 630, the processing device may obtain a DT of the masked polynomial for a plurality of elements of a finite field, e.g., a finite GF(2^{m}) field. In some implementations, obtaining the DT of the masked polynomial may include performing a plurality of iterations, e.g., as illustrated by the callout portion of FIG. 6. For example, at block 632, method 600 may include identifying, based on the masked polynomial, a first auxiliary polynomial (e.g., g1(x) 218 in FIG. 4) and a second auxiliary polynomial (e.g., g2(x) 220 in FIG. 4). At block 634, method 600 may continue with the processing device computing the DT of the masked polynomial using a set of basis vectors for the finite field, the first auxiliary polynomial, and the DT of the second auxiliary polynomial. In some implementations, computing the DT of the masked polynomial may be performed as described above in conjunction with FIG. 2 and method 500 of FIGS. 5A-B.

At block 640, method 600 may include computing the DT of the polynomial (e.g., as part of AFFT unmasking 436 in FIG. 4) using the DT of the masked polynomial (e.g., masked polynomial AFFT 432 in FIG. 4). At block 650, the processing device performing method 600 may compute a plaintext output corresponding to the ciphertext input using the DT of the polynomial, e.g., by identifying locations of roots of the polynomial and/or performing any other pertinent computations according to a specific cryptographic algorithm being used.

In some implementations, polynomial masking may be additive masking, f_{M}(x)=f(x)+m(x). In some implementations, polynomial masking may be multiplicative masking, f_{M}(x)=f(x)·m(x). In the instances of multiplicative masking, method 600 may include identifying roots of the masked polynomial f_{M} (x) that are not roots of the masking polynomial m(x), e.g., by constructing m(x) that does not have roots in the field over which polynomial f(x) is defined (e.g., GF(2^{m})) or by selecting m(x) that does not have roots in a portion (e.g., code support) of that field.

In some implementations, polynomial masking of method 600 may be combined with at least some aspects of basis randomization of method 500. More specifically, the set of basis vectors used in block 634 (e.g., basis vectors β₁ . . . βₘ in block 206 in FIG. 4) may be obtained by randomizing a stored set of basis vectors (e.g., starting basis α₁ . . . αₘ 204 in FIG. 4) using any of the randomization techniques described in conjunction with FIG. 2 and/or method 500 of FIG. 5. For example, randomizing the stored set of basis vectors may include multiplying the stored set of basis vectors by a randomization matrix that has one or more random elements. In some implementations, randomizing the stored set of basis vectors may include permuting two or more vectors of the stored set of basis vectors. Operations of method 600 may include multiple iterations, e.g., performed as described in conjunction with FIG. 2 and FIG. 5B.

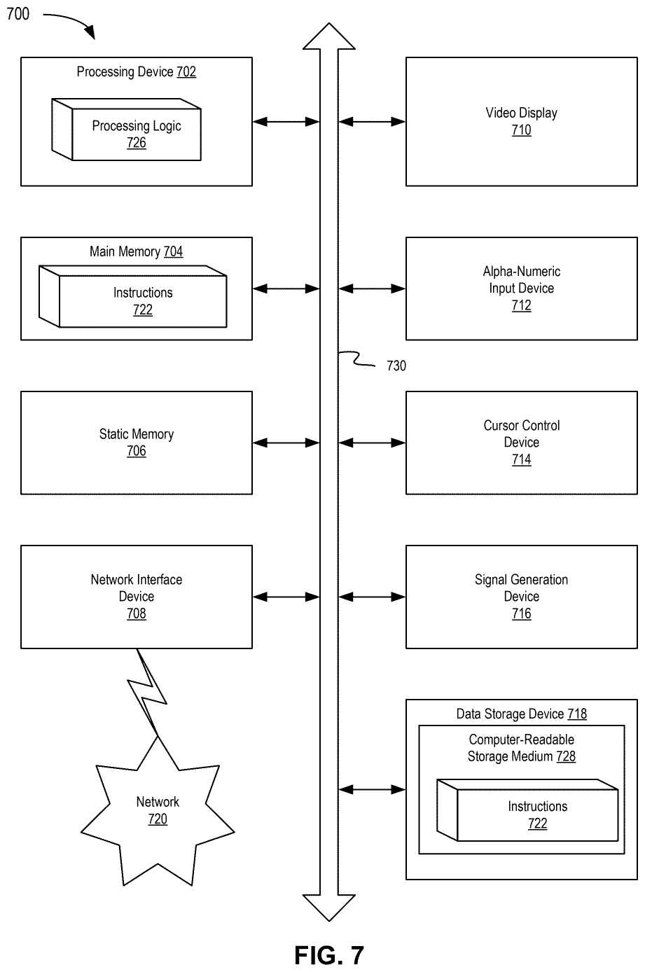

FIG. 7 depicts a block diagram of an example computer system 700 operating in accordance with one or more aspects of the present disclosure. In various illustrative examples, computer system 700 may represent computer system 102, illustrated in FIG. 1. Example computer system 700 may be connected to other computer systems in a LAN, an intranet, an extranet, and/or the Internet. Computer system 700 may operate in the capacity of a server in a client-server network environment. Computer system 700 may be a personal computer (PC), a set-top box (STB), a server, a network router, switch or bridge, or any device capable of executing a set of instructions (sequential or otherwise) that specify actions to be taken by that device. Further, while only a single example computer system is illustrated, the term “computer” shall also be taken to include any collection of computers that individually or jointly execute a set (or multiple sets) of instructions to perform any one or more of the methods discussed herein.

Example computer system 700 may include a processing device 702 (also referred to as a processor or CPU), which may include processing logic 726, a main memory 704 (e.g., read-only memory (ROM), flash memory, dynamic random access memory (DRAM) such as synchronous DRAM (SDRAM), etc.), a static memory 706 (e.g., flash memory, static random access memory (SRAM), etc.), and a secondary memory (e.g., a data storage device 718), which may communicate with each other via a bus 730.

Processing device 702 represents one or more general-purpose processing devices such as a microprocessor, central processing unit, or the like. More particularly, processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. In accordance with one or more aspects of the present disclosure, processing device 702 may be configured to execute instructions implementing method 500 of protection, against side channel attacks, of cryptographic operations that use additive Fast Fourier Transforms by randomization of basis vectors and method 600 of protection, against side channel attacks, of cryptographic operations that use additive Fast Fourier Transforms by polynomial masking.

Example computer system 700 may further comprise a network interface device 708, which may be communicatively coupled to a network 720. Example computer system 700 may further comprise a video display 710 (e.g., a liquid crystal display (LCD), a touch screen, or a cathode ray tube (CRT)), an alphanumeric input device 712 (e.g., a keyboard), a cursor control device 714 (e.g., a mouse), and an acoustic signal generation device 716 (e.g., a speaker).

Data storage device 718 may include a computer-readable storage medium (or, more specifically, a non-transitory computer-readable storage medium) 728 on which is stored one or more sets of executable instructions 722. In accordance with one or more aspects of the present disclosure, executable instructions 722 may comprise executable instructions implementing method 500 of protection, against side channel attacks, of cryptographic operations that use additive Fast Fourier Transforms by randomization of basis vectors and method 600 of protection, against side channel attacks, of cryptographic operations that use additive Fast Fourier Transforms by polynomial masking.

Executable instructions 722 may also reside, completely or at least partially, within main memory 704 and/or within processing device 702 during execution thereof by example computer system 700, main memory 704 and processing device 702 also constituting computer-readable storage media. Executable instructions 722 may further be transmitted or received over a network via network interface device 708.

While the computer-readable storage medium 728 is shown in FIG. 7 as a single medium, the term “computer-readable storage medium” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages may be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but may be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

What is claimed is:

1. A method to perform a cryptographic operation, the method comprising:
identifying, by a processing device, a polynomial associated with a ciphertext input into the cryptographic operation;
obtaining, by the processing device, a discrete transform (DT) of the polynomial for a plurality of elements of a finite field, wherein obtaining the DT of the polynomial comprises:
randomizing a set of basis vectors for the finite field to obtain a first randomized set of basis vectors;
obtaining, using the first randomized set of basis vectors, a first reduced set of basis vectors;
identifying, based on the polynomial, a first auxiliary polynomial and a second auxiliary polynomial; and
computing the DT of the polynomial using the first reduced set of basis vectors, the DT of the first auxiliary polynomial, and the DT of the second auxiliary polynomial; and
computing, by the processing device, a plaintext output corresponding to the ciphertext input using the DT of the polynomial.

2. The method of claim 1, wherein the DT comprises Additive Fast Fourier Transform.

3. The method of claim 1, wherein randomizing the set of basis vectors comprises multiplying the set of basis vectors by a randomization matrix comprising one or more random elements.

4. The method of claim 1, wherein randomizing the set of basis vectors comprises permuting two or more vectors of the set of basis vectors.

5. The method of claim 1, wherein the DT of the first auxiliary polynomial is obtained using operations that comprise:
randomizing the first reduced set of basis vectors to obtain a second randomized set of basis vectors;
obtaining, using the second randomized set of basis vectors, a second reduced set of basis vectors;
identifying, based on the first auxiliary polynomial, a third auxiliary polynomial and a fourth auxiliary polynomial; and
computing the DT of the first auxiliary polynomial using the second reduced set of basis vectors, the DT of the third auxiliary polynomial, and the DT of the fourth auxiliary polynomial.

6. The method of claim 1, wherein the polynomial is obtained by combining an input polynomial with a masking polynomial, and wherein computing the plaintext output comprises:
obtaining the DT of the input polynomial using the DT of the polynomial; and
computing the plaintext output using the DT of the input polynomial.

7. The method of claim 6, wherein the masking polynomial is one of a first-degree polynomial or a second-degree polynomial.

8. The method of claim 1, wherein the finite field comprises a GF(2^{m}) field, wherein m is an integer number.

9. The method of claim 1, wherein the polynomial is representative of a locator polynomial of an error correction code, and wherein computing the plaintext output comprises identifying one or more roots of the locator polynomial using the DT of the polynomial.

10. A method to perform a cryptographic operation, the method comprising:
identifying, by a processing device, a polynomial associated with a ciphertext input into the cryptographic operation;
combining, by the processing device, the polynomial with a masking polynomial to obtain a masked polynomial;
obtaining, by the processing device, a discrete transform (DT) of the masked polynomial for a plurality of elements of a finite field, wherein obtaining the DT of the masked polynomial comprises:
identifying, based on the masked polynomial, a first auxiliary polynomial and a second auxiliary polynomial; and
computing the DT of the masked polynomial using a set of basis vectors for the finite field, the first auxiliary polynomial, and the DT of the second auxiliary polynomial;
computing, by the processing device and using the DT of the masked polynomial, the DT of the polynomial; and
obtaining, by the processing device, a plaintext output corresponding to the ciphertext input using the DT of the polynomial.

11. The method of claim 10, wherein the set of basis vectors is obtained by randomizing a stored set of basis vectors.

12. The method of claim 11, wherein randomizing the stored set of basis vectors comprises:
multiplying the stored set of basis vectors by an invertible randomization matrix comprising one or more random elements.

13. The method of claim 11, wherein randomizing the stored set of basis vectors comprises permuting two or more vectors of the stored set of basis vectors.

14. The method of claim 10, wherein combining the polynomial comprises adding the polynomial to the masking polynomial to obtain the masked polynomial.

15. The method of claim 10, wherein combining the polynomial comprises multiplying the polynomial by the masking polynomial to obtain the masked polynomial, the method further comprising:
identifying roots of the masked polynomial that are not roots of the masking polynomial.

16. A system to perform a cryptographic operation, the system comprising:
a memory device; and
a processing device communicatively coupled to the memory device, the processing device to:
identify a polynomial associated with a ciphertext input into the cryptographic operation;
obtain a discrete transform (DT) of the polynomial for a plurality of elements of a finite field, wherein to obtain the DT the processing device is to:
randomize a set of basis vectors for the finite field to obtain a first randomized set of basis vectors;
obtain, using the first randomized set of basis vectors, a first reduced set of basis vectors;
identify, based on the polynomial, a first auxiliary polynomial and a second auxiliary polynomial; and
compute the DT of the polynomial using the first reduced set of basis vectors, the DT of the first auxiliary polynomial, and the DT of the second auxiliary polynomial; and
compute a plaintext output corresponding to the ciphertext input using the DT of the polynomial.

17. The system of claim 16, wherein to randomize the set of basis vectors, the processing device is to:
multiply the set of basis vectors by an invertible randomization matrix comprising one or more random elements.

18. The system of claim 16, wherein to mask the set of basis vectors, the processing device is to:
permute two or more vectors of the set of basis vectors.

19. The system of claim 16, wherein to compute the DT of the first auxiliary polynomial, the processing device is to:
randomize the first reduced set of basis vectors to obtain a second randomized set of basis vectors;
obtain, using the second randomized set of basis vectors, a second reduced set of basis vectors;
identify, based on the first auxiliary polynomial, a third auxiliary polynomial and a fourth auxiliary polynomial; and
compute the DT of the first auxiliary polynomial using the second reduced set of basis vectors, the DT of the third auxiliary polynomial, and the DT of the fourth auxiliary polynomial.

20. The system of claim 16, wherein the polynomial is combined using an input polynomial and a masking polynomial, and wherein to compute the plaintext output, the processing device is to:
obtain the DT of the input polynomial using the DT of the polynomial; and
compute the plaintext output using the DT of the input polynomial.

21. The system of claim 20, wherein the masking polynomial is one of a first-degree polynomial or a second-degree polynomial.

22. The system of claim 16, wherein the polynomial is representative of a locator polynomial of an error correction code, and wherein to compute the plaintext output, the processing device is to:
identify one or more roots of the locator polynomial using the DT of the polynomial.
